(19) United States
(12) Patent Application Publication
(10) Pub. No.: US 2025/0168351 A1
(43) Pub. Date: May 22, 2025

(54) METHOD AND COMPUTING DEVICE FOR ADAPTIVELY ENCODING VIDEO FOR LOW LATENCY STREAMING

(71) Applicant: SAMUNG ELECTRONICS CO., LTD., Suwon-si (KR)

(72) Inventor: Kiwon YOO, Suwon-si (KR)

(73) Assignee: SAMUNG ELECTRONICS CO., LTD., Suwon-si (KR)

(21) Appl. No.: 19/028,492

(22) Filed: Jan. 17, 2025

Related U.S. Application Data
(63) Continuation of application No. PCT/KR2023/008784, filed on Jun. 23, 2023.

(30) Foreign Application Priority Data
Jul. 29, 2022 (KR) 10-2022-0095008

(51) Int. Cl. H04N 19/136; H04N 19/172; H04N 19/85

(52) U.S. Cl. CPC H04N 19/136; H04N 19/172; H04N 19/85

(57) ABSTRACT

A method, performed by an electronic device, for adaptively encoding a video, including: identifying a network bandwidth; determining whether a scene transition occurs in a first frame, based a plurality of partial frames corresponding to the first frame and at least one second frame reproduced before the first frame; selecting a preprocessing specification corresponding to the first frame, based on the network bandwidth and a result of the determining; preprocessing the first frame based on the preprocessing specification; and encoding the first frame.

### CROSS-REFERENCE TO RELATED APPLICATION

This application is a continuation of International Application No. PCT/KR2023/008784, filed on Jun. 23, 2023, in the Korean Intellectual Property Receiving Office, which is based on and claims priority to Korean Provisional Application Number 10-2022-0095008 filed on Jul. 29, 2022, in the Korean Intellectual Property Office, the disclosures of which are incorporated by reference herein in their entireties.

### BACKGROUND

### 1. Field

The disclosure relates to a computing device for adaptively performing encoding according to characteristics of a video and an operating method thereof.

### 2. Description of Related Art

Recently, distributed adaptive streaming systems have been used as technology for video streaming in over-the-top (OTT) services or the like. Distributed adaptive streaming systems pre-encode streams of various codec standards and bit rates/resolutions/frame rates in order to provide streaming to user devices. When a user device requests streaming, distributed adaptive streaming systems provide streams matching a network state of a user and processing performance of a device by using a distributed server (e.g., an edge server) physically close to the user. However, this is pre-encoding using a high-performance server, which is different from real-time encoding.

When a server provides real-time video streaming by using real-time encoding, the image quality and/or frame rate are adjusted based on network bandwidth conditions. However, because the compression difficulty varies depending on characteristics of a video, there are cases where the image quality does not need to be unnecessarily reduced during encoding.

In encoding for providing real-time video streaming, there is a need to provide efficient video streaming through adaptive encoding, based on a network bandwidth and image quality prediction of video frames.

### SUMMARY

Provided is an adaptive encoding method for real-time video streaming, a computing device that quickly detects a scene transition in a video, predicts image quality of a current frame, based on frame information of same scenes, and determines a preprocessing specification of a frame accordingly, and an operating method thereof.

Additional aspects will be set forth in part in the description which follows and, in part, will be apparent from the description, or may be learned by practice of the presented embodiments.

In accordance with an aspect of the disclosure, a method, performed by an electronic device, for adaptively encoding a video, includes: identifying a network bandwidth; determining whether a scene transition occurs in a first frame, based a plurality of partial frames corresponding to the first frame and at least one second frame reproduced before the first frame; selecting a preprocessing specification corresponding to the first frame, based on the network bandwidth and a result of the determining; preprocessing the first frame based on the preprocessing specification; and encoding the first frame.

The selecting of the preprocessing specification may include: selecting a first preprocessing specification based on the result of the determining indicating that the scene transition occurs in the first frame; and selecting a second preprocessing specification based on the result of the determining indicating that the scene transition does not occur in the first frame.

The selecting of the preprocessing specification may further include obtaining a predicted image quality of the first frame after the encoding based on the second preprocessing specification being selected, and the first preprocessing specification may correspond to the network bandwidth and the second preprocessing specification may correspond to the predicted image quality.

The obtaining of the predicted image quality may include: obtaining frame information including bandwidth information and image quality information corresponding to the at least one second frame; and obtaining the predicted image quality based on the frame information, and the first frame and the at least one second frame may be included in a same scene.

According to the second preprocessing specification, a resolution of the first frame may be reduced based on the predicted image quality being less than a first threshold value, and increased based on the predicted image quality being greater than or equal to a second threshold value.

The method may further include generating frame information including bandwidth information and image quality information corresponding to the encoded first frame, and the frame information may be used for preprocessing of a frame reproduced after the first frame.

The selecting of the preprocessing specification may include maintaining the preprocessing specification of the first frame based on determining that a preprocessing specification change history exists for the at least one second frame within a certain interval from the first frame.

In accordance with an aspect of the disclosure, an electronic device for adaptively encoding a video, includes: a communication interface; at least one processor; and a memory configured to store one or more instructions which, when executed by the at least one processor, cause the electronic device to: identify a network bandwidth; determine whether a scene transition occurs in a first frame, based on a plurality of partial frames corresponding to the first frame and at least one second frame reproduced before the first frame; select a preprocessing specification corresponding to the first frame, based on the network bandwidth and a result of the determining; preprocess the first frame, based on the preprocessing specification; and encode the first frame.

The one or more instructions may further cause the electronic device to: select a first preprocessing specification based on the result of the determining indicating that the scene transition occurs in the first frame; and select a second preprocessing specification based on the result of the determining indicating that the scene transition does not occur in the first frame.

The one or more instructions may further cause the electronic device to obtain a predicted image quality of the first frame after the encoding based on the second preprocessing specification being selected, and the first preprocessing specification may correspond to the network bandwidth and the second preprocessing specification may correspond to the predicted image quality.

The one or more instructions may further cause the electronic device to: obtain frame information including bandwidth information and image quality information corresponding to the at least one second frame; and obtain the predicted image quality based on the frame information, and the first frame and the at least one second frame may be included in a same scene.

According to the second preprocessing specification, a resolution of the first frame may be reduced based on the predicted image quality being less than a first threshold value, and increased based on the predicted image quality being greater than or equal to a second threshold value.

The one or more instructions may further cause the electronic device to generate frame information including bandwidth information and image quality information corresponding to the encoded first frame, and the frame information may be used for preprocessing of a frame reproduced after the first frame.

The one or more instructions may further cause the electronic device to execute the one or more instructions to maintain the preprocessing specification of the first frame when based on determining that a preprocessing specification change history exists for the at least one second frame within a certain interval from the first frame.

In accordance with an aspect of the disclosure, a computer-readable recording medium has recorded thereon instructions which, when executed by at least one processor of an electronic device for adaptively encoding a video, cause the electronic device to: identify a network bandwidth; determine whether a scene transition occurs in a first frame, based a plurality of partial frames corresponding to the first frame and at least one second frame reproduced before the first frame; select a preprocessing specification corresponding to the first frame, based on the network bandwidth and a result of the determining; preprocess the first frame based on the preprocessing specification; and encode the first frame.

### DESCRIPTION OF DRAWINGS

The above and other aspects, features, and advantages of certain embodiments of the present disclosure will be more apparent from the following description taken in conjunction with the accompanying drawings, in which:

FIG. 1 is a diagram schematically illustrating an operation of a computing device according to an embodiment of the present disclosure;

FIG. 2 is a block diagram illustrating a configuration of a computing device according to an embodiment of the present disclosure;

FIG. 3 is a diagram for describing an example to which adaptive encoding of a computing device, according to an embodiment of the present disclosure, is applicable;

FIG. 4 is a flowchart for describing a video encoding method of a computing device, according to an embodiment of the present disclosure;

FIG. 5 is a diagram for describing an operation in which a computing device detects a scene transition by using partial frames, according to an embodiment of the present disclosure;

FIG. 6 is a diagram for describing an operation in which a computing device determines a preprocessing specification, according to an embodiment of the present disclosure;

FIG. 7 is a diagram for describing an example of a preprocessing specification that a computing device adaptively selects according to whether a scene transition occurs, according to an embodiment of the present disclosure;

FIG. 8 is a diagram for describing an operation of determining predicted image quality of a first frame when a computing device uses a second preprocessing specification, according to an embodiment of the present disclosure;

FIG. 9 is a diagram for describing an operation in which a computing device determines predicted image quality of a first frame, according to an embodiment of the present disclosure;

FIG. 10 is a diagram for describing an operation in which a computing device generates a preprocessing specification change history and frame information, according to an embodiment of the present disclosure; and

FIG. 11 is a diagram for describing an operation in which a computing device changes or maintains a preprocessing specification of a first frame, according to an embodiment of the present disclosure.

### DETAILED DESCRIPTION

The terms as used herein are briefly described and some embodiments of the present disclosure are described in detail. Throughout the present disclosure, the expression “at least one of a, b or c” indicates only a, only b, only c, both a and b, both a and c, both b and c, all of a, b, and c, or variations thereof.

As for the terms as used in the present disclosure, common terms that are currently widely used are selected as much as possible while taking into account the functions in the present disclosure. However, the terms may vary depending on the intention of those of ordinary skill in the art, legal precedents, the emergence of new technology, and the like. Also, some terms may be arbitrarily selected. The meanings of such terms are described in detail in the description of the present disclosure. Therefore, the terms as used herein should be defined based on the meaning of the terms and the description throughout the present disclosure rather than simply the names of the terms.

Singular forms as used herein are intended to include the corresponding plural forms as well unless the context clearly indicates otherwise. All terms including technical or scientific terms as used herein have the same meaning as commonly understood by those of ordinary skill in the art. It will be understood that although the terms “first,” “second,” etc. may be used to describe various elements, these elements should not be limited by these terms. These terms are only used to distinguish one element from another.

Throughout the disclosure, the expression “a portion includes a certain element” means that the portion further includes other elements rather than excludes other elements unless otherwise stated. Also, the terms such as “unit” and “module” described in the specification mean units that process at least one function or operation, and may be implemented as hardware, software, or a combination of hardware and software.

Hereinafter, embodiments of the present disclosure are described in detail with reference to the accompanying drawings, so that those of ordinary skill in the art may more easily carry out the present disclosure. However, the present disclosure may be implemented in various different forms and is not limited to the particular embodiments described herein. In order to more clearly explain the present disclosure, some parts may be omitted in the drawings, and similar reference numerals may be assigned to similar parts throughout the specification.

Hereinafter, embodiments of the present disclosure are described in detail with reference to the accompanying drawings.

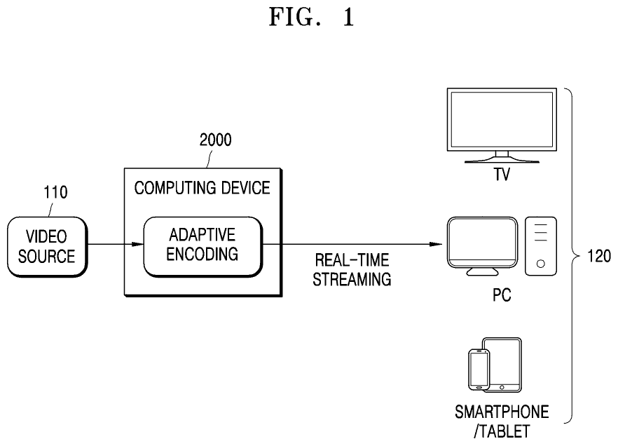

FIG. 1 is a diagram schematically illustrating an operation of a computing device according to an embodiment of the present disclosure.

Referring to FIG. 1, a computing device 2000 according to an embodiment may include an encoder. In embodiments, the computing device 2000 may also be referred to as an electronic device. The computing device 2000 may adaptively encode a video source 110 and perform real-time streaming to electronic devices 120 (e.g., a television (TV), a personal computer (PC), a smartphone, a tablet, etc.).

In the real-time streaming, a stable network and data transmission are important rather than image quality of a video to be transmitted due to various restrictions of real-time encoding and low-latency transmission is important.

The adaptive encoding may refer to technology that adaptively encodes for stream transmission in which consistent quality of playback media is guaranteed in the electronic devices 120. When real-time streaming is performed over wired and wireless networks with high bandwidth fluctuations, conventional adaptive encoding performs encoding based only on network bandwidth conditions in order to send optimal media according to network conditions. For example, conventional adaptive encoding uses a method of adjusting a video compression ratio, reducing a resolution/frame rate of an original video, and adjusting encoder operation settings (e.g., group of pictures (GOP) size, coding tree unit (CTU) size, etc.), based on network bandwidth conditions.

The adaptive encoding that is performed by the computing device 2000 of the present disclosure adaptively determines a preprocessing operation by reflecting a difference in compression image quality according to characteristics of the video as well as the network bandwidth conditions. For example, in a case where a scene to which a frame belongs is static and has low complexity and thus has low compression difficulty, even when the network bandwidth condition is not good, the computing device 2000 may compress an original frame as it is without reducing the image quality of the frame, thereby minimizing image quality degradation.

The computing device 2000 according to an embodiment may identify whether a scene transition occurs in a current frame. The computing device 2000 may select different preprocessing specifications according to whether the scene transition is detected. For example, when the scene transition is detected in the current frame, the computing device 2000 may select a preprocessing specification to preprocess the frame (e.g., change the image quality, frame rate, etc.) according to the network bandwidth. When the scene transition is not detected in the current frame, for example when the scene transition does not occur in the current frame and the current frame is the same scene as the previous frames, the computing device 2000 may predict the image quality of the current frame after encoding, based on information of the previous frames. In this case, the computing device 2000 may select a specification to preprocess the frames, based on predicted image quality and an available bandwidth.

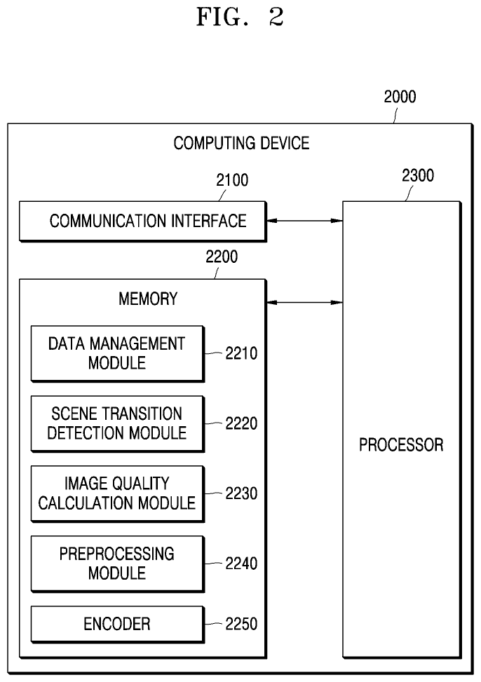

FIG. 2 is a block diagram illustrating the configuration of the computing device according to an embodiment of the present disclosure.

Referring to FIG. 2, the computing device 2000 according to an embodiment may include a communication interface, a memory 2200, and a processor 2300.

The communication interface 2100 may perform data communication with other electronic devices under the control by the processor 2300.

The communication interface 2100 may include a communication circuit that may perform data communication between the computing device 2000 and other devices by using at least one of data communication schemes including, for example, wired local area network (LAN), wireless LAN, Wireless Fidelity (Wi-Fi), Bluetooth, ZigBee, Wi-Fi Direct (WFD), Infrared Data Association (IrDA), Bluetooth Low Energy (BLE), Near Field Communication (NFC), Wireless Broadband Internet (Wibro), World Interoperability for Microwave Access (WiMAX), Shared Wireless Access Protocol (SWAP), Wireless Gigabit Alliance (WiGig), and radio frequency (RF) communication.

The communication interface 2100 according to an embodiment may transmit encoded video to an electronic device for real-time video streaming.

The memory 2200 may store instructions, a data structure, and program code, which are readable by the processor 2300. In the disclosed embodiments, operations that are performed by the processor 2300 may be implemented by executing instructions or codes of a program stored in the memory 2200.

The memory 2200 may include flash memory-type memory, hard disk-type memory, multimedia card micro-type memory, or card-type memory (e.g., secure digital (SD) or extreme digital (XD) memory), may include a non-volatile memory including at least one of read-only memory (ROM), electrically erasable programmable read-only memory (EEPROM), or programmable read-only memory (PROM), and may include a volatile memory, such as random access memory (RAM) or static random access memory (SRAM).

The memory 2200 according to an embodiment may store one or more instructions and/or programs that enable the computing device 2000 to adaptively encode a video. For example, a data management module 2210, a scene transition detection module 2220, an image quality calculation module 2230, a preprocessing module 2240, and an encoder 2250 may be stored in the memory 2200.

The processor 2300 may control the overall operations of the computing device 2000. For example, the processor 2300 may execute one or more instructions of the program stored in the memory 2200 to control the overall operations of the computing device 2000 to adaptively encode a video. One or more processors may be provided.

The processor 2300 may include, for example, at least one of central processing units (CPUs), microprocessors, graphic processing units (GPUs), application specific integrated circuits (ASICs), digital signal processors (DSPs), digital signal processing devices (DSPDs), programmable logic devices (PLDs), field programmable gate arrays (FPGAs), application processors (APs), neural processing units, or dedicated artificial intelligence processors designed with a hardware structure specialized for processing an artificial intelligence model, but the present disclosure is not limited thereto.

In an embodiment, the processor 2300 may execute the data management module 2210 to manage data used for adaptive encoding. When the preprocessing specification for encoding a video is changed, the processor 2300 may store information related to the changed preprocessing specification as a preprocessing specification change history. For example, the processor 2300 may determine the preprocessing specification as a first preprocessing specification, based on identification of a scene transition in a first frame. In this case, because there was no scene transition in the frames before the preprocessing specification was determined as the first preprocessing specification, the existing preprocessing specification may have been a second preprocessing specification. The computing device 2000 may change the second preprocessing specification to the first preprocessing specification and store the change as the preprocessing specification change history. The processor 2300 may generate and store frame information while preprocessing and encoding the frame. The frame information may include a scene identification number of a frame, a frame identification number, a bandwidth, and image quality information. For example, the processor 2300 may compare the first frame before encoding with the first frame after encoding and generate, as the frame information, image quality information indicating an image quality level of the first frame after compression. In addition, the processor 2300 may store the bandwidth information of the first frame and the scene identification number of the frame as the frame information. Frame information of the previous frames may be used for preprocessing and encoding of the current frame.

In an embodiment, the processor 2300 may execute the scene transition detection module 2220 to detect the scene transition in the current frame. When detecting the scene transition, the processor 2300 may detect whether the scene transition occurs by using only a portion of the frame. In an embodiment, the processor 2300 may determine a split number indicating how much of a portion of the frame to use. The split number is used to divide a frame into partial frames. The processor 2300 identifies whether a scene transition occurs in the first frame, based on at least some partial frames of the first frame (e.g., a plurality of partial frames corresponding to or associated with the first frame) and the second frame. The second frame may refer to a frame before the first frame, for example a frame that is reproduced before the first frame or is included previous to or prior to the first frame in a time order. The scene transition may be detected by using various scene transition detection algorithms. For example, direct comparison between pixels of two frames, comparison of statistical values of frame pixels, histogram comparison, or the like may be used, but the present disclosure is not limited thereto.

In an embodiment, the processor 2300 may execute the image quality calculation module 2230 to calculate the image quality of the encoded frame. The processor 2300 may compare the first frame before encoding with the first frame after encoding and generate image quality information indicating an image quality level of the first frame after compression. The image quality information may be included in the frame information. The method by which the processor 2300 generates the image quality information may use various algorithms for measuring errors between images. For example, video multi-method assessment fusion (VMAF), structural similarity index map (SSIM), peak signal-to-noise ratio (PSNR), mean of absolute differences (MAD), sum of squared differences (SSD), or the like may be used, but the present disclosure is not limited thereto. The processor 2300 may execute the image quality calculation module 2230 to predict the image quality after encoding prior to encoding the frame. When determining the predicted image quality of the first frame, the processor 2300 may use second frames of the same scene as the first frame. The processor 2300 may obtain frame information including the bandwidth and image quality information of the second frame. The processor 2300 may obtain predicted image quality of the first frame after encoding, based on the image quality and bandwidth information of the second frames of the same scene as the first frame.

In an embodiment, the processor 2300 may execute the preprocessing module 2240 to preprocess the frame. The processor 2300 may preprocess the frame, based on at least some of the network bandwidth, the occurrence or non-occurrence of the scene transition, the image quality of the frame, and the preprocessing specification. The preprocessing specification may be provided in plurality. A detailed operation in which the processor 2300 performs preprocessing by selectively applying the first preprocessing specification or the second preprocessing specification, based on the occurrence or non-occurrence of the scene transition, the network bandwidth, the image quality, or the like, is described below.

In an embodiment, the processor 2300 may encode a video by using the encoder 2250. When the resolution and/or frame rate of the first frame is changed by preprocessing, the processor 2300 may reset a sequence parameter set (SPS) to the changed resolution and encode the first frame into an intra-coded frame (I-frame). When the resolution and/or frame rate is not changed, the processor 2300 may encode the first frame into an inter-coded frame (e.g., a predicted frame (P-frame) or a bidirectional predicted frame (B-frame)).

The computing device 2000 according to an embodiment detects the scene transition by using only at least some partial frames constituting a portion of the first frame rather than using the entire frame, and adaptively performs preprocessing and encoding by taking into account the network bandwidth conditions and image quality, thereby minimizing delay in providing real-time streaming.

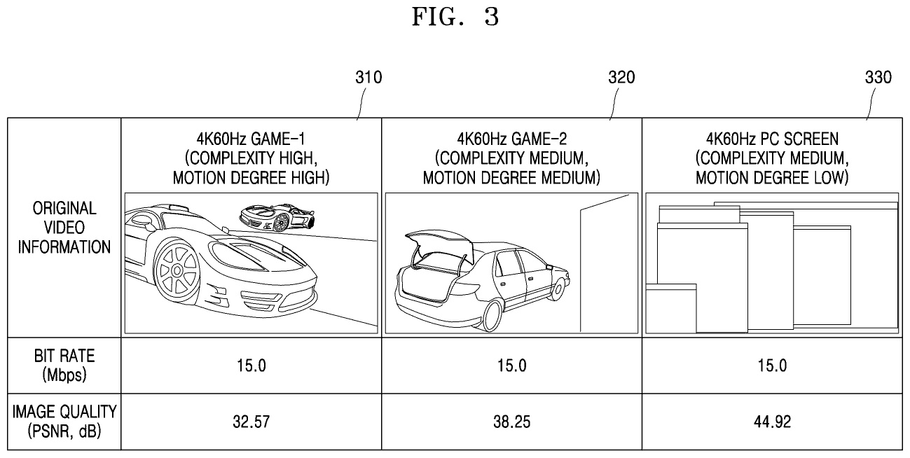

FIG. 3 is a diagram for describing an example to which the adaptive encoding of the computing device, according to an embodiment of the present disclosure, is applicable.

Referring to FIG. 3, the image quality after encoding may vary depending on different characteristics of a video source. For example, the complexity and motion degree of a video, for example, a video of a user's game play, such as a first video 310 received from a first video source, may be classified as having a “high” complexity and a “high” motion degree. A video, e.g., a game introduction video and/or a production clip video, such as a second video 320 received from a second video source, may be classified as having a “medium” complexity and a “medium” motion degree. For example, this may mean that the complexity of the second video 320 is relatively lower than the complexity of the first video 310, and that the motion degree of the second video 320 is relatively lower than the motion degree of the first video 310. As an example of encoding, in a case where the first video source 310 and the second video source 320 are encoded at the same bit rate (e.g., 15 megabits per second (Mbps)), when calculating a peak signal-to-noise ratio (PSNR) indicating compression loss of a video, the PSNR of the first video source 310 is 32.57 dB and the PSNR of the second video source 320 is 38.25 dB, which shows the difference of 5.68 dB. For example, the loss of image quality during compression of the second video source 320 with low complexity and motion degree may be less than the loss of image quality during compression of the first video 310.

However, a video of a PC screen (e.g., screen mirroring), such as a third video 330 received from a third video source, may be classified as having a “medium” complexity and a “low” motion degree. For example, this may mean that the complexity of the third video 330 is relatively lower than the complexity of the first video 310 and is the same as, or similar to, the complexity of the second video 320, and that the motion degree of the third video 330 is relatively lower than the motion degree of the first video 310 and the motion degree of the third video 330. In the case of the video of the PC screen, an actual motion occurring within a video in a typical usage environment occurs in a single application used by a user and a change within the video occurs within a controllable range of a keyboard and a mouse. Therefore, although the complexity may be high, the motion degree is low, making compression easy. For example, when the third video source 330 is encoded at the same bit rate (e.g., 15 Mbps) as the first video source 310 and the second video source 320, the PSNR of the third video source 330 is 44.92 dB, which may result in less loss of image quality during compression than in the case of the video sources described above.

As in the examples described above with reference to FIG. 3, when the preprocessing operation is determined based only on the bandwidth state without reflecting the difference in compression image quality according to different characteristics of the video, unnecessary image quality degradation may occur. For example, when the network bandwidth state is not good, preprocessing is performed to lower the resolution according to a general encoding method. However, when the scene to which the frame belongs is static and the complexity is low, the compression difficulty is low, and therefore, the original frame may be compressed as it is, without any preprocessing that reduces image quality.

The computing device 2000 according to an embodiment of the present disclosure may include an encoder that adaptively encodes a video by determining an image quality prediction value and a scene transition of an input frame and adaptively performing preprocessing on a frame based thereon. Hereinafter, examples of operations in which the computing device 2000 of the present disclosure encodes a video for real-time streaming are described.

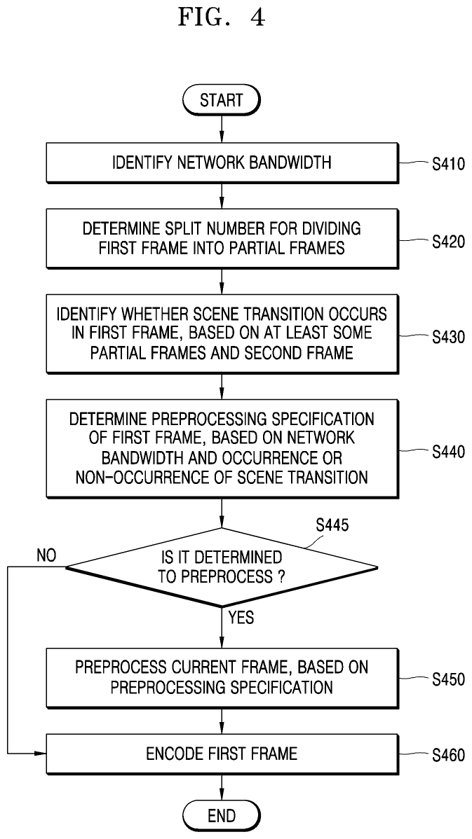

FIG. 4 is a flowchart for describing the video encoding method of the computing device, according to an embodiment of the present disclosure.

At operation S410, the computing device 2000 according to an embodiment identifies a network bandwidth. The computing device may predict a current network bandwidth state between a transmitting end and a receiving end, based on transmission and reception information of previous packets. For example, the computing device 2000 may calculate an available bandwidth during encoding of each frame by using information of round trip time (RTT) and round trip delay (RTD) measured during a packet transmission and reception process.

At operation S420, the computing device 2000 according to an embodiment determines a split number for dividing a first frame into partial frames. The first frame may be a current frame to be encoded. One partial frame may be one of multiple divisions of one frame. For example, the computing device 2000 may determine the split number to be eight (“8”). In this case, the partial frame may be one of eight divisions of one frame. The split number may be variable.

At operation S430, the computing device 2000 according to an embodiment identifies whether a scene transition occurs in the first frame, based on at least some partial frames and a second frame. The second frame may refer to a frame before the first frame.

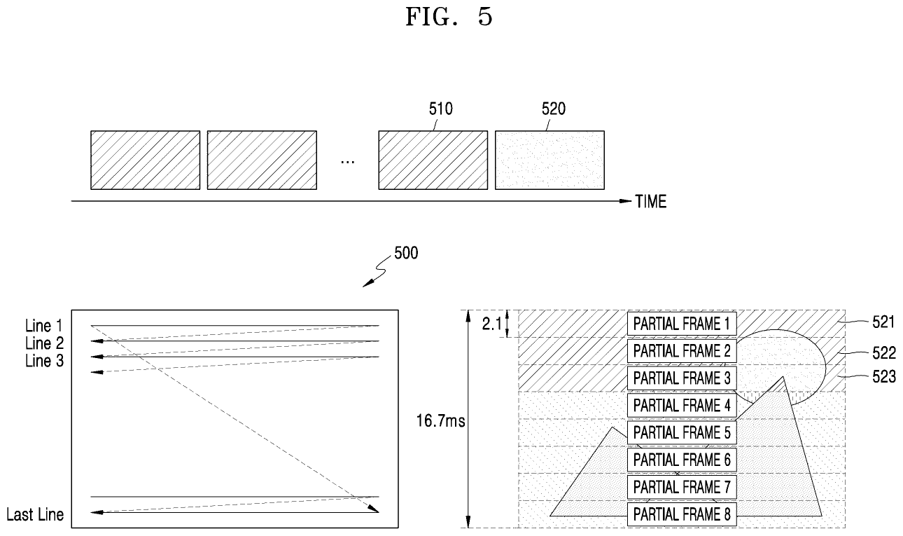

In an embodiment, the second frame may be a frame immediately before the first frame. The computing device 2000 may detect the scene transition by comparing at least some partial frames of the first frame with the second frame. In real-time streaming, frame preprocessing and encoding need to be fast. The computing device 2000 according to an embodiment may minimize frame delay by detecting the scene transition by using only at least some partial frames constituting a portion of the first frame rather than receiving the entire first frame. A detailed operation by which the computing device 2000 detects the scene transition is further described in the description of FIG. 5.

At operation S440, the computing device 2000 according to an embodiment determines a preprocessing specification of the first frame, based on the network bandwidth and the occurrence or non-occurrence of the scene transition.

In an embodiment, the computing device 2000 may selectively change and apply different preprocessing specifications, based on the available bandwidth and the occurrence or non-occurrence of the scene transition.

The preprocessing specification may be a preprocessing specification (first preprocessing specification) that changes the resolution and/or frame rate of the first frame, based on the available network bandwidth. For example, for a raw video with 4K resolution and 60 Hz frame rate, the preprocessing specification based on the network bandwidth may be as follows. The preprocessing specification based on the network bandwidth, expressed in terms of resolution/frame rate, may be 4K/60 Hz when the bandwidth prediction value is greater than or equal to 20 Mbps, 2K/60 Hz when the bandwidth prediction value is greater than or equal to 10 Mbps and less than 20 Mbps, and HD/60 Hz when the bandwidth prediction value is less than 10 Mbps. Specifically, for an original video of 4K/60 Hz, when the bandwidth prediction value is 30 Mbps, the current frame may be determined not to be preprocessed in accordance with the preprocessing specification. Alternatively, when the bandwidth prediction value is 15 Mbps due to network congestion or other reasons, the preprocessing specification may be determined to be 2K/60 Hz, and the preprocessing may be determined to be performed to convert the resolution of the current frame from 4K to 2K.

In another example, the preprocessing specification may be a preprocessing specification (second preprocessing specification) that changes the resolution and/or frame rate of the first frame, based on the image quality prediction value of the first frame after encoding. For example, the resolution of the first frame may be reduced when the predicted image quality of the first frame is less than a first threshold value and the resolution of the first frame may be increased when the predicted image quality is greater than or equal to a second threshold value, but the present disclosure is not limited thereto.

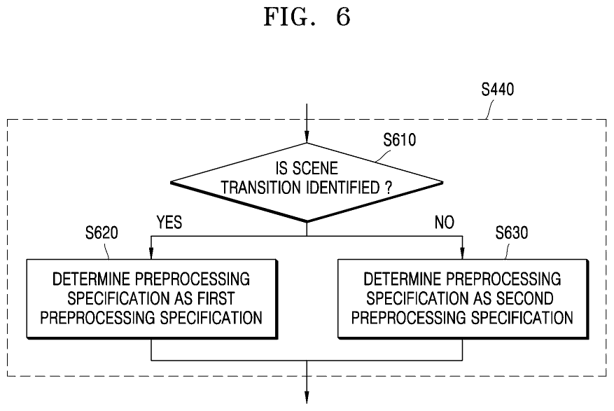

In an embodiment, when the scene transition is detected, the computing device 2000 may determine a preprocessing specification to be applied to the first frame, and when the scene transition is not detected, the computing device 2000 may determine a preprocessing specification to be applied to the first frame by using frame information of the second frames belonging to the same scene. A detailed operation by which the computing device 2000 determines the preprocessing specification is further described in the description of FIG. 6.

At operation S445, the computing device 2000 according to an embodiment identifies whether it is determined to preprocess the first frame. The computing device 2000 may determine whether the preprocessing is to be performed on the first frame, based on the preprocessing specification.

The computing device 2000 may perform operation S450 when the computing device 2000 determines to preprocess the first frame, and may perform operation S460 when the computing device 2000 determines not to preprocess the first frame.

At operation S450, the computing device 2000 according to an embodiment preprocesses the first frame, based on the preprocessing specification. The computing device 2000 may change at least one of the image quality and the frame rate of the first frame in accordance with the preprocessing specification determined at operation S440. For example, the computing device 2000 may reduce or increase the image quality of the current frame, based on the preprocessing specification. Alternatively, the computing device 2000 may reduce or increase the frame rate of the video, based on the preprocessing specification. Specifically, when the determined preprocessing specification is a preprocessing specification that changes the resolution and/or the frame rate of the first frame, based on the available network bandwidth, and the bandwidth prediction value is 15 Mbps for a 4K/60 Hz video, the preprocessing that reduces the resolution of the current frame may be performed according to the predefined preprocessing specification of 2K/60 Hz.

At operation S460, the computing device 2000 according to an embodiment encodes the first frame. When the resolution and/or the frame rate of the first frame is changed by the preprocessing, the computing device 2000 may reset an SPS to the changed resolution and encode the first frame into an I-frame. When the resolution and/or the frame rate is not changed, the computing device 2000 may encode the first frame into an inter-coded frame (e.g., a P-frame or a B-frame).

FIG. 5 is a diagram for describing an operation in which the computing device detects the scene transition by using the partial frame, according to an embodiment of the present disclosure.

In describing FIG. 5, a first frame 520 is a current frame, and a frame before the first frame 520 is a second frame 510. According to some embodiments, for convenience of explanation, a frame immediately before the first frame 520 may be referred to as the second frame 510, but the present disclosure is not limited thereto, and the second frame 510 may be at least one frame before the first frame 520. A case where a scene of the second frame 510 is different from a scene of the first frame 520, which may mean for example that the scene transition occurs in the first frame 520, is described as an example.

In an embodiment, the computing device 2000 may determine a split number for dividing the first frame 520 into partial frames. For example, when the computing device 2000 determines the split number to be eight (“8”), the first frame 520 may be divided into a total of 8 partial frames, such as a first partial frame 521, a second partial frame 522, and a third partial frame 523.

Referring to diagram 500, when the computing device 2000 scans frame data, pixel data of the frame may be scanned in a raster scan manner. A raster scan order may refer to an order in which pixel data is input in line units from the upper left to the lower right, for example an order in which pixel data of a first line (illustrated as “Line 1”) is input from a leftmost pixel to a rightmost pixel, then pixel data of a second line (illustrated as “Line 2”) is input from a leftmost pixel to a rightmost pixel, then pixel data of a third line (illustrated as “Line 3”) is input from a leftmost pixel to a rightmost pixel, continuing on until a rightmost pixel of a last line (illustrated as “Last Line”) is reached. First, the computing device 2000 may determine whether the scene transition occurs by using upper lines (e.g., partial frames) of the input frame.

The computing device 2000 may detect whether the scene transition occurs in the first frame, based on at least some partial frames and the second frame. For example, the computing device 2000 may compare the first partial frame 521 with the second frame 510 and detect whether the scene transition occurs. In another example, the computing device 2000 may compare the first partial frame 521 and the second partial frame 522 with the second frame 510 and detect whether the scene transition occurs. In another example, the computing device 2000 may compare the first partial frame 521, the second partial frame 522, and the third partial frame 523 with the second frame 510 and detect whether the scene transition occurs. The method by which the computing device 2000 according to an embodiment detects whether the scene transition occurs may use various scene transition detection algorithms. For example, direct comparison between pixels of two frames, comparison of statistical values of frame pixels, histogram comparison, or the like may be used, but the present disclosure is not limited thereto.

The computing device 2000 may minimize frame delay by detecting the scene transition by using only at least some partial frames constituting a portion of the first frame rather than using the entire first frame. For example, for a video with a frame rate of 60 Hz, the delay for one frame is about 16.67 milliseconds (ms). However, when the computing device 2000 uses only the 8-divided first partial frame 521 during the detection of the scene transition, the delay is about 2.08 ms, and when the computing device 2000 uses only a 16-divided partial frame, the delay is about 1.04 ms. Therefore, the computing device 2000 may detect the scene transition with reduced delay by using the partial frames.

FIG. 6 is a diagram for describing an operation in which the computing device determines the preprocessing specification, according to an embodiment of the present disclosure.

Operations of FIG. 6 may correspond to operation S440 of FIG. 4, which determines the preprocessing specification of the first frame, based on the network bandwidth and the occurrence or non-occurrence of the scene transition.

At operation S610, the computing device 2000 according to an embodiment may adaptively determine the preprocessing specification by selectively performing operation S620 or S630, based on the identification or non-identification of the scene transition in the first frame.

At operation S620, the computing device 2000 may determine the preprocessing specification as a first preprocessing specification, based on the identification of the scene transition in the first frame. In some embodiments, the first preprocessing specification may be for changing the image quality of the first frame and/or the frame rate of the video according to the available bandwidth. When the first frame is a scene transition frame, the computing device 2000 may determine the specification for preprocessing the first frame, based on the available bandwidth of the current frame, without using information related to the second frame, which is at least one frame before the first frame.

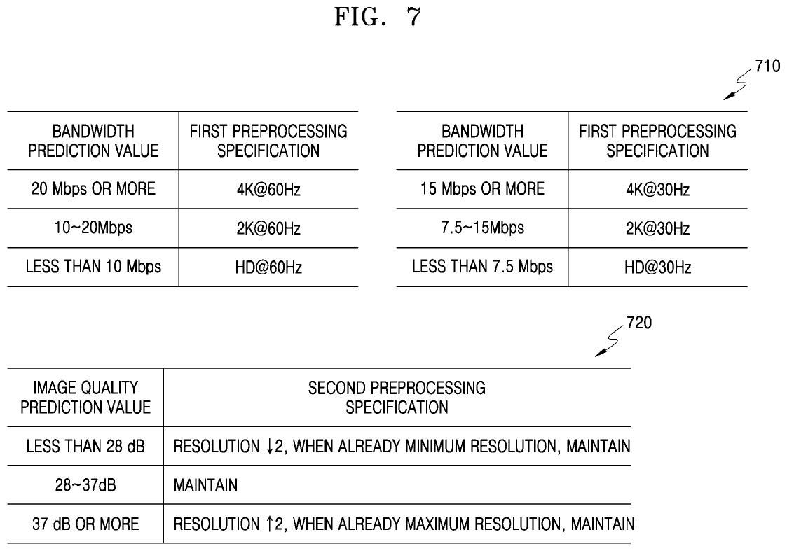

At operation S630, the computing device 2000 may determine the preprocessing specification as a second preprocessing specification, based on the non-identification of the scene transition in the first frame. In some embodiments, the second preprocessing specification may be for predicting the image quality of the first frame after encoding and changing the resolution of the first frame before encoding, based on the predicted image quality value. When the first frame is not a scene transition frame, the computing device 2000 may determine the specification for preprocessing the first frame, based on information related to the second frames identified as the same scenes as the first frame. Examples of the first preprocessing specification and the second preprocessing specification are further described with reference to FIG. 7.

FIG. 7 is a diagram for describing an example of the preprocessing specification that the computing device adaptively selects according to the scene transition occurs, according to an embodiment of the present disclosure.

Referring to FIG. 7, the computing device 2000 according to an embodiment may determine the preprocessing specification of the first frame as a first preprocessing specification 710 when the scene transition is identified in the first frame, and may determine the preprocessing specification of the first frame as a second preprocessing specification 720 when the scene transition is not identified in the first frame.

The first preprocessing specification 710 that is applied when the scene transition is identified in the first frame may be for changing the image quality of the first frame and/or the frame rate of the video according to the available bandwidth. In this case, the computing device 2000 may determine whether to preprocess the first frame, based on the bandwidth prediction value obtained through operation S410 of FIG. 4 and the first preprocessing specification 710.

For example, a case where an original video has 4K resolution and 60 Hz frame rate and the scene transition is identified in the first frame is described as an example. When the bandwidth prediction value is greater than or equal to 20 Mbps, the available bandwidth is sufficient to process the first frame, and thus, the computing device 2000 may determine not to preprocess the first frame. When the bandwidth prediction value is greater than or equal to 10 Mbps and less than 20 Mbps, the computing device 2000 may determine to preprocess the first frame so that the image quality of the first frame is reduced to 2K resolution. When the bandwidth prediction value is less than 10 Mbps, the computing device 2000 may determine to preprocess the first frame so that the image quality of the first frame is reduced to HD resolution. However, the bandwidth prediction value, image quality, and frame rate of the first preprocessing specification 710 illustrated in FIG. 7 are only examples, and the present disclosure is not limited thereto.

The second preprocessing specification 720 that is applied when the scene transition is not identified in the first frame may be for predicting the image quality of the first frame after encoding and changing the resolution of the first frame before encoding, based on the predicted image quality value. In this case, the computing device 2000 may determine whether to preprocess the second frame, based on frame information of the second frames of the same scene as the first frame and the second preprocessing specification 720. The frame information may include a scene identification number of a frame, a frame identification number, a bandwidth, and image quality information. The computing device 2000 may determine the predicted image quality of the first frame, based on frame information of the second frames.

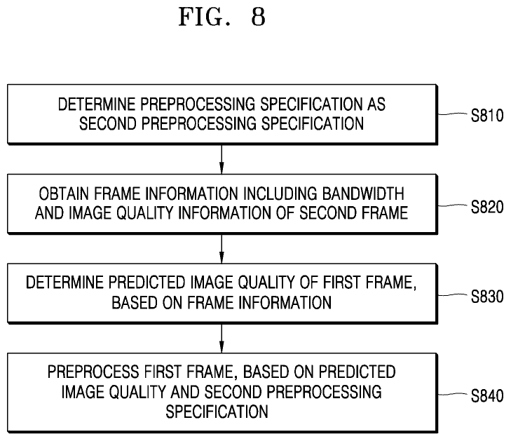

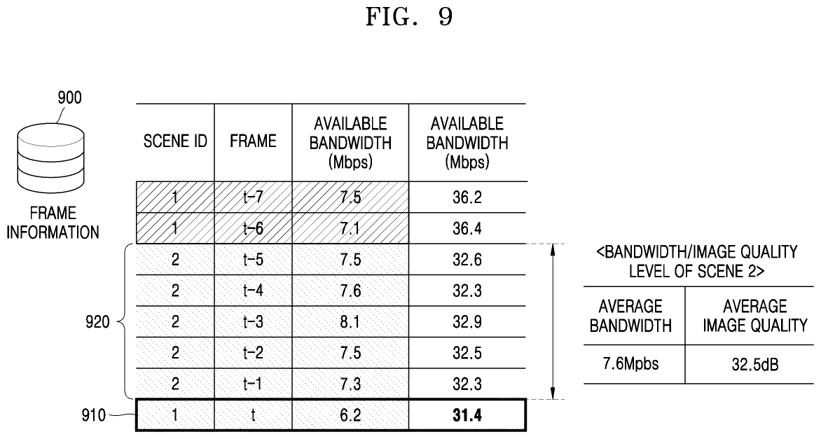

For example, when the image quality prediction value (PSNR value) of the first frame after encoding is less than 28 dB, the computing device 2000 may determine to preprocess the first frame so that the image quality of the first frame is reduced (e.g., reduced to ½). In this case, when the image quality of the first frame is already the lowest image quality, the computing device 2000 may determine not to preprocess the first frame. When the image quality prediction value (PSNR value) is greater than or equal to 28 dB and less than 37 dB, the computing device 2000 may determine not to preprocess the first frame. When the image quality prediction value (PSNR value) is greater than or equal to 37 dB, the computing device 2000 may determine to preprocess the first frame so that the image quality of the first frame is increased (e.g., increased twice). However, the range of the image quality prediction value of the second preprocessing specification 720 illustrated in FIG. 7 and the values of the degree of increase or reduction in image quality are only examples, and the present disclosure is not limited thereto. In addition, the operation of determining the predicted image quality of the first frame when the computing device 2000 uses the second preprocessing specification 720 is further described with reference to FIGS. 8 and 9.

FIG. 8 is a diagram for describing the operation of determining the predicted image quality of the first frame when the computing device uses the second preprocessing specification, according to an embodiment of the present disclosure.

At operation S810, the computing device 2000 according to an embodiment determines the preprocessing specification as the second preprocessing specification. The computing device 2000 may determine the preprocessing specification of the first frame as the second preprocessing specification, based on the non-identification of the scene transition in the first frame. Operation S810 may correspond to operation S630 of FIG. 6.

At operation S820, the computing device 2000 according to an embodiment obtains frame information including bandwidth and image quality information of the second frame. The frame information may include a scene identification number of a frame, a frame identification number, a bandwidth, and image quality information.

At operation S830, the computing device 2000 according to an embodiment determines the predicted image quality of the first frame, based on the frame information. The computing device 2000 may identify the second frames of the same scene as the first frame, based on the scene identification number included in the frame information. The computing device 2000 may obtain predicted image quality of the first frame after encoding, based on the image quality and bandwidth information of the second frames of the same scene as the first frame. This is further described with reference to FIG. 9. Because the computing device 2000 uses frame information of the same scenes, the frame information may be reset whenever the scene transitions or may be stored separately for each scene.

At operation S840, the computing device 2000 according to an embodiment preprocesses the first frame, based on the predicted image quality and the second preprocessing specification. The second preprocessing specification may be a preprocessing specification of the first frame according to the predicted image quality. For example, in the second preprocessing specification, the resolution of the first frame may be reduced when the predicted image quality of the first frame is less than a first threshold value and the resolution of the first frame may be increased when the predicted image quality is greater than or equal to a second threshold value, but the present disclosure is not limited thereto.

FIG. 9 is a diagram for describing the operation in which the computing device determines the predicted image quality of the first frame, according to an embodiment of the present disclosure.

In an embodiment, the computing device 2000 may obtain frame information of frames before the first frame in order to determine the predicted image quality of the first frame 910. The frame information may include a scene identification number of a frame, a frame identification number, a bandwidth, and image quality information.

In an embodiment, the computing device 2000 may detect whether the scene transition occurs in the first frame 910 by using partial frames of the first frame 910. Because an example of this is described above, a detailed description thereof is omitted. Referring to a table of FIG. 9, since the scene of the first frame is classified as scene ID 2, the scene of the first frame may be the same scene as previous frames.

The computing device 2000 may calculate an average bandwidth and average image quality of a second frames 920 of scene ID 2, based on frame information of the second frames 920 identified as the same scene as the first frame. The computing device 2000 may predict the image quality of the first frame 910 after encoding by using Equation 1, based on the average bandwidth and the average image quality of the second frames 920. Equation 1 relates to an example for improving the PSNR by +3 dB when the first frame 910 is compressed twice.

$$EstQ ( t ) = EstQ ( scene ) + ( \frac{BW ( t ) - EstBW ( scene )}{\frac{EstBW ( scene )}{2}} ) \times 3. \qquad ( Equation 1 )$$

EstQ (t) is the predicted image quality of the first frame 910 that is the t^{th} frame, BW (t) is the available bandwidth of the first frame 910 that is the t^{th} frame, EstQ (scene) is the average image quality of the second frames 920 of the same scenes as the first frame 910, and EstBW (scene) is the average bandwidth of the second frames 920 of the same scenes as the first frame 910.

For example, when the average bandwidth and the average quality (PSNR) of the second frames 920 are respectively 7.6 Mbps and 32.5 dB and the available bandwidth of the first frame 910 is 6.2 Mbps, the predicted quality value of the first frame 910 may be 31.4 dB. However, this is an example. In addition to the PSNR and the image quality described above, image quality information normalized by a bit rate may be used.

In an embodiment, when the computing device 2000 determines the predicted image quality of the first frame 910, the computing device 200 may preprocess the first frame 910, based on second preprocessing specification that is the preprocessing specification of the first frame 910 according to the predicted image quality. For example, referring to the second preprocessing specification 720 of FIG. 7, since the predicted image quality of the first frame 910 is 31.4 dB, the first frame 910 may be determined to maintain the current resolution without preprocessing that changes the resolution.

In an embodiment, the computing device 2000 may apply weight values when determining the predicted quality of the first frame 910. For example, the computing device 2000 may apply weight values, based on the distance between the first frame 910 and each of the second frames 920. Specifically, the computing device 2000 may apply the lowest weight value to the (t-5)^{th} frame among the second frames 920 that is the farthest from the first frame 910, and may apply the highest weight value to the (t-1)^{th} frame among the second frames 920 that is the closest from the first frame 910.

In an embodiment, when determining the predicted image quality of the first frame 910, the computing device 2000 may determine the predicted image quality, based on a result of analyzing the change trend of the image quality values of the previous frames. In this case, various known algorithms for trend analysis may be used.

In an embodiment, when determining the predicted image quality of the first frame 910, the computing device 2000 may determine the predicted image quality only by using image quality information of the previous frames without taking into account bandwidth information. In this case, information such as the change trend of the image quality values and the average of the image qualities may be used.

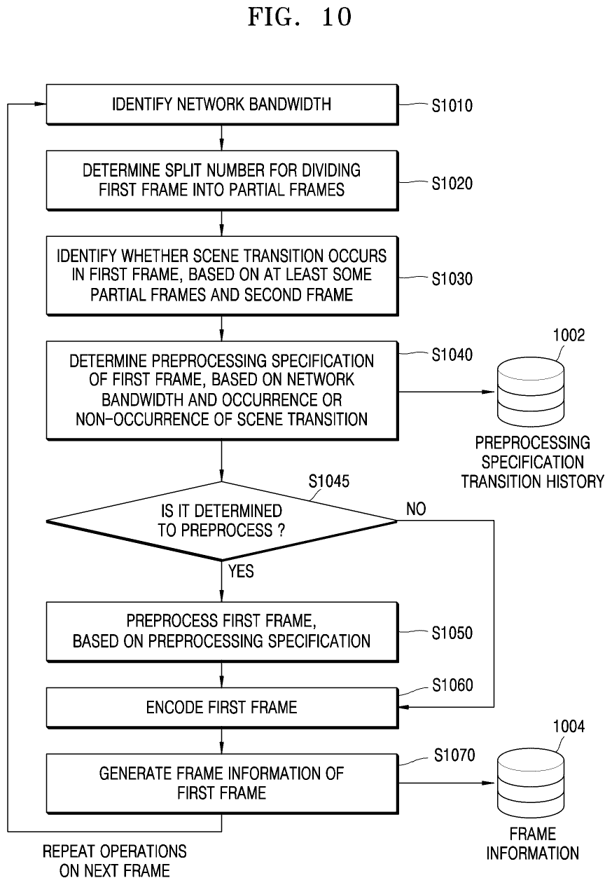

FIG. 10 is a diagram for describing an operation in which the computing device generates a preprocessing specification change history and frame information, according to an embodiment of the present disclosure.

In describing FIG. 10, the same description as provided with reference to FIG. 4 is omitted.

At operation S1010, the computing device 2000 according to an embodiment identifies a network bandwidth. The computing device 2000 may predict a current network bandwidth state between a transmitting end and a receiving end, based on transmission and reception information of previous packets.

At operation S1020, the computing device 2000 according to an embodiment determines a split number for dividing a first frame into partial frames.

At operation S1030, the computing device 2000 according to an embodiment identifies whether a scene transition occurs in the first frame, based on at least some partial frames and a second frame.

At operation S1040, the computing device 2000 according to an embodiment determines a preprocessing specification of the first frame, based on the network bandwidth and the occurrence or non-occurrence of the scene transition. The computing device 2000 may determine the preprocessing specification for each frame of the video, perform preprocessing, and then encode the frame. When the preprocessing specification is changed, the computing device 2000 may store information related to the changed preprocessing specification in a preprocessing specification change history 1002. For example, the computing device 2000 may determine the preprocessing specification as the first preprocessing specification, based on identification of the scene transition in the first frame. In this case, since there was no scene transition in the frames before the preprocessing specification was determined as the first preprocessing specification, the existing preprocessing specification may have been a second preprocessing specification. The computing device 2000 may change the second preprocessing specification to the first preprocessing specification and store the change as the preprocessing specification change history 1002.

At operation S1045, the computing device 2000 according to an embodiment identifies whether it is determined to preprocess the first frame.

At operation S1050, the computing device 2000 according to an embodiment preprocesses the first frame, based on the preprocessing specification.

At operation S1060, the computing device 2000 according to an embodiment encodes the first frame.

At operation S1070, the computing device 2000 according to an embodiment generates frame information 1004 of the encoded first frame. The computing device 2000 may compare the first frame before encoding with the first frame after encoding and store, in the frame information 1004, image quality information indicating an image quality level of the first frame after compression. In addition, the computing device 2000 may store bandwidth information of the first frame in the frame information 1004. The frame information of the first frame may be used for preprocessing of the frame after the first frame.

The method by which the computing device 2000 generates the image quality information of the first frame may use various algorithms for measuring errors between images. For example, VMAF, SSIM, PSNR, MAD, SSD, or the like may be used, but the present disclosure is not limited thereto.

The computing device 2000 may normalize the image quality information of the first frame by using the available bandwidth or compression ratio information of the frame. The computing device 2000 may perform data processing to reduce parameters for determining, estimating, or otherwise obtaining a predicted image quality. For example, the computing device 2000 may determine, estimate, or otherwise obtain a predicted image quality of a current frame by using a result of dividing an image quality value by a bandwidth value.

The computing device 2000 may repeat operations S1010 to S1070 for each frame included in the video. For example, when the computing device 2000 determines the preprocessing specification for the frame after the first frame and performs preprocessing and encoding, the preprocessing specification change history 1002 and the frame information 1004 generated when preprocessing and encoding the first frame may be used.

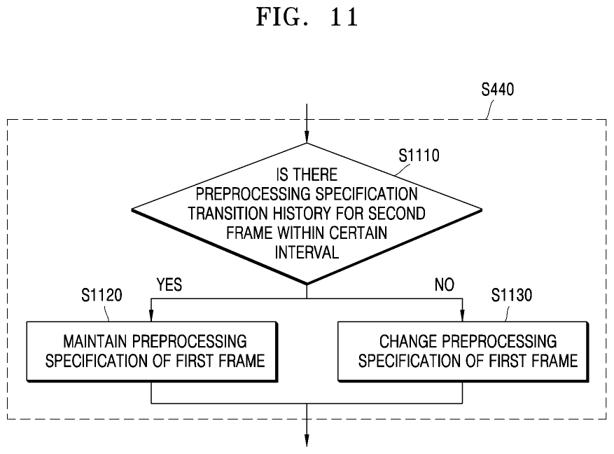

FIG. 11 is a diagram for describing an operation in which the computing device changes or maintains the preprocessing specification of the first frame, according to an embodiment of the present disclosure.

Operations of FIG. 11 may correspond to operation S440 of FIG. 4, which determines the preprocessing specification of the first frame, based on the network bandwidth and the occurrence or non-occurrence of the scene transition.

At operation S1110, the computing device 2000 according to an embodiment may identify whether there is the preprocessing specification change history for the second frame within a certain interval from the first frame (e.g., whether the preprocessing specification change history for the second frame exists or occurs within a certain interval from the first frame). The computing device 2000 may determine whether to change to the preprocessing specification determined at operation S440, based on the preprocessing specification change history. Operation S1120 may be performed when there is the preprocessing specification change history for the second frame within the certain interval and operation S1130 may be performed when there is no preprocessing specification change history for the second frame within the certain interval.

At operation S1120, the computing device 2000 according to an embodiment maintains the preprocessing specification of the first frame. When there is the preprocessing specification change history for the second frame within the certain interval, the computing device 2000 may select an existing preprocessing specification without changing the preprocessing specification of the first frame. After the preprocessing specification is changed, the preprocessing specification is not changed again within a certain time, in order to prevent the deterioration of image quality due to frequent resolution/frame rate changes and ensure a time margin for compression image quality to stabilize after inserting I-frames in encoding.

For example, the computing device 2000 may determine the preprocessing specification as the first preprocessing specification, based on identification of the scene transition. In this case, when the previous preprocessing specification was the second preprocessing specification and the time point at which the preprocessing specification was changed to the second preprocessing specification was a change in a frame within a certain interval, the computing device 2000 may not select the determined first preprocessing specification and may maintain the preprocessing specification of the first frame as the second preprocessing specification.

For example, the computing device 2000 may determine the preprocessing specification as the first preprocessing specification, based on non-identification of the scene transition. In this case, when the previous preprocessing specification was the first preprocessing specification and the time point at which the preprocessing specification was changed to the first preprocessing specification was a change in a frame within a certain interval, the computing device 2000 may not select the determined second preprocessing specification and may maintain the preprocessing specification of the first frame as the first preprocessing specification.

At operation S1130, the computing device 2000 according to an embodiment changes the preprocessing specification of the first frame. When there is no preprocessing specification change history for the second frame within a certain interval, the computing device 2000 may change the preprocessing specification of the first frame from the first preprocessing specification to the second preprocessing specification or from the second preprocessing specification to the first preprocessing specification according to the embodiments described above.

Embodiments of the present disclosure may be implemented in the form of a computer-readable recording medium including computer-executable instructions, such as program modules executable by a computer. A computer-readable recording medium may be any available media that are accessible by the computer and may include any volatile and non-volatile media and any removable and non-removable media. In addition, the computer-readable recording medium may include a computer storage medium and a communication medium. The computer storage medium may include any volatile, non-volatile, removable, and non-removable media that are implemented in any method or technology for storage of information, such as computer-readable instructions, data structures, program modules, or other data. The communication medium may typically include computer-readable instructions, data structures, or other data of a modulated data signal, such as program modules.

Also, the computer-readable recording medium may be provided in the form of a non-transitory computer-readable recording medium. The “non-transitory storage medium” is a tangible device and only means not including a signal (e.g., electromagnetic waves). This term does not distinguish between a case where data is semi-permanently stored in a storage medium and a case where data is temporarily stored in a storage medium. For example, the non-transitory storage medium may include a buffer in which data is temporarily stored.

A method according to an embodiment of the present disclosure may be provided by being included in a computer program product. The computer program product may be traded between a seller and a buyer as commodities. The computer program product may be distributed in the form of a machine-readable storage medium (e.g., compact disc read-only memory (CD-ROM)), or may be distributed (e.g., downloaded or uploaded) online either via an application store or directly between two user devices (e.g., smartphones). In the case of the online distribution, at least a part of a computer program product (e.g., downloadable app) is stored at least temporarily on a machine-readable storage medium, such as a server of a manufacturer, a server of an application store, or memory of a relay server, or may be temporarily generated.

The foregoing description of the present disclosure is for illustrative purposes only, and those of ordinary skill in the art to which the present disclosure pertains will understand that modifications into other specific forms may be made thereto without changing the technical spirit or essential features of the present disclosure. Therefore, it should be understood that the embodiments of the present disclosure described above are illustrative in all aspects and are not restrictive. For example, the components described as being singular may be implemented in a distributed manner. Similarly, the components described as being distributed may be implemented in a combined form.

The scope of the present disclosure is defined by the appended claims rather than the above detailed description, and all changes or modifications derived from the meaning and scope of the claims and equivalent concepts thereof should be construed as falling within the scope of the disclosure.

What is claimed is:

1. A method, performed by an electronic device, for adaptively encoding a video, the method comprising:
identifying a network bandwidth;
determining whether a scene transition occurs in a first frame, based a plurality of partial frames corresponding to the first frame and at least one second frame reproduced before the first frame;
selecting a preprocessing specification corresponding to the first frame, based on the network bandwidth and a result of the determining;
preprocessing the first frame based on the preprocessing specification; and
encoding the first frame.

2. The method of claim 1, wherein the selecting of the preprocessing specification comprises:
selecting a first preprocessing specification based on the result of the determining indicating that the scene transition occurs in the first frame; and
selecting a second preprocessing specification based on the result of the determining indicating that the scene transition does not occur in the first frame.

3. The method of claim 2, wherein the selecting of the preprocessing specification further comprises obtaining a predicted image quality of the first frame after the encoding based on the second preprocessing specification being selected, and
wherein the first preprocessing specification corresponds to the network bandwidth and the second preprocessing specification corresponds to the predicted image quality.

4. The method of claim 3, wherein the obtaining of the predicted image quality comprises:
obtaining frame information comprising bandwidth information and image quality information corresponding to the at least one second frame; and
obtaining the predicted image quality based on the frame information,
wherein the first frame and the at least one second frame are included in a same scene.

5. The method of claim 3, wherein according to the second preprocessing specification, a resolution of the first frame is reduced based on the predicted image quality being less than a first threshold value, and increased based on the predicted image quality being greater than or equal to a second threshold value.

6. The method of claim 2, further comprising generating frame information comprising bandwidth information and image quality information corresponding to the encoded first frame,
wherein the frame information is used for preprocessing of a frame reproduced after the first frame.

7. The method of claim 6, wherein the selecting of the preprocessing specification comprises maintaining the preprocessing specification of the first frame based on determining that a preprocessing specification change history exists for the at least one second frame within a certain interval from the first frame.

8. An electronic device for adaptively encoding a video, the electronic device comprising:
a communication interface;
at least one processor; and
a memory configured to store one or more instructions which, when executed by the at least one processor, cause the electronic device to:
identify a network bandwidth;
determine whether a scene transition occurs in a first frame, based on a plurality of partial frames corresponding to the first frame and at least one second frame reproduced before the first frame;
select a preprocessing specification corresponding to the first frame, based on the network bandwidth and a result of the determining;
preprocess the first frame, based on the preprocessing specification; and
encode the first frame.

9. The electronic device of claim 8, wherein the one or more instructions further cause the electronic device to:
select a first preprocessing specification based on the result of the determining indicating that the scene transition occurs in the first frame; and
select a second preprocessing specification based on the result of the determining indicating that the scene transition does not occur in the first frame.

10. The electronic device of claim 9, wherein the one or more instructions further cause the electronic device to obtain a predicted image quality of the first frame after the encoding based on the second preprocessing specification being selected, and
Wherein the first preprocessing specification corresponds to the network bandwidth and the second preprocessing specification corresponds to the predicted image quality.

11. The electronic device of claim 10, wherein the one or more instructions further cause the electronic device to:
obtain frame information comprising bandwidth information and image quality information corresponding to the at least one second frame; and
obtain the predicted image quality based on the frame information,
wherein the first frame and the at least one second frame are included in a same scene.

12. The electronic device of claim 10, wherein according to the second preprocessing specification, a resolution of the first frame is reduced based on the predicted image quality being less than a first threshold value, and increased based on the predicted image quality being greater than or equal to a second threshold value.

13. The electronic device of claim 9, wherein the one or more instructions further cause the electronic device to generate frame information comprising bandwidth information and image quality information corresponding to the encoded first frame, and
wherein the frame information is used for preprocessing of a frame reproduced after the first frame.

14. The electronic device of claim 13, wherein the one or more instructions further cause the electronic device to execute the one or more instructions to maintain the preprocessing specification of the first frame when based on determining that a preprocessing specification change history exists for the at least one second frame within a certain interval from the first frame.

15. A computer-readable recording medium having recorded thereon instructions which, when executed by at least one processor of an electronic device for adaptively encoding a video, cause the electronic device to:
identify a network bandwidth;
determine whether a scene transition occurs in a first frame, based a plurality of partial frames corresponding to the first frame and at least one second frame reproduced before the first frame;
select a preprocessing specification corresponding to the first frame, based on the network bandwidth and a result of the determining;
preprocess the first frame based on the preprocessing specification; and
encode the first frame.
